(19) United States
(12) Patent Application Publication
(10) Pub. No.: US 2017/0160462 A1
(43) Pub. Date: Jun. 8, 2017

(54) DISPLAY PANEL AND DISPLAY DEVICE INCLUDING THE SAME

(71) Applicant: Wuhan China Star Optoelectronics Technology Co., Ltd., Wuhan, Hubei (CN)

(72) Inventors: Lingyan CHEN, Shenzhen, Guangdong (CN); Gege ZHOU, Shenzhen, Guangdong (CN)

(73) Assignee: Wuhan China Star Optoelectronics Technology Co., Ltd., Wuhan, Hubei (CN)

(21) Appl. No.: 14/888,412

(22) PCT Filed: Aug. 20, 2015
(86) PCT No.: PCT/CN2015/087628

§ 371 Date: Oct. 30, 2015

(30) Foreign Application Priority Data
Jul. 27, 2015 (CN) 201510445937.4

(51) Int. Cl. F21V 8/00

(52) U.S. Cl. CPC G02B 6/0036

(57) ABSTRACT

The invention teaches a display panel, comprising: a substrate; a plurality of pixels; and a black matrix; wherein the pixels are arranged in an array on the substrate; each pixel comprises a plurality of sub-pixels; the black matrix is a grid on the substrate among the sub-pixels; the black matrix between two neighboring pixels is of a same width; and the black matrix between two neighboring sub-pixels of each pixel are of different widths. The invention also teaches a display device including the display panel. Light beams projected from a backlight module onto the display panel are diagonally aligned, and are not diffracted by the black matrix. Therefore no interference fringe is produced and the display quality of the display device is not compromised. Light guiding elements on the backlight module are not required to align with the sub-pixels, achieving significantly reduced manufacture complexity.

### BACKGROUND OF THE INVENTION

1. Field of the Invention

The present invention relates to display techniques, and in particular to a display panel and a display device including the display panel.

2. The Related Arts

In recent years, as the light emitting diode (LED) technology is continuously evolving, LED lighting efficiency is greatly enhanced. Compared to the conventional fluorescent lamps or power-saving lamps, LEDs have advantages such as low power consumption, long operational life, high safety, short emission response time, and small dimension, and therefore are gradually applied in display devices.

FIGS. 1A and 1B are perspective and side-view diagrams of an existing display device 1.

As illustrated, the display device 1 contains a display panel 11 and a backlight module 12. The backlight module 12 emits light beams L that travel through the display panel 11 so as to manifest the image on the display panel 11.

The backlight module 12 is positioned to a major side of the display panel 11, and contains two edge-lit light sources 121, a board-like light guide plate 122, and a number of light guiding elements 123. In this example, the light sources 121 use LEDs, and are positioned along two lateral sides of the light guide plate 122. Light beams L from the LEDs enter the light guide plate 122 through light incident faces I. The light guiding elements 123 are formed by printing white ink diagonally on a bottom side B1 of the light guide plate 122. The light beams L undergo total reflection within the light guide plate 122 until they are directed by the light guiding elements 123 to project out of a light projection face O of the light guide plate 122 onto the display panel 11.

When light beams L are projected out of the light projection face O of the light guide plate 122, the light beams L form a pattern of diagonally alternating dark and bright stripes on the light projection face O. Due to the display panel 11's light blocking layer with interleaving strips (i.e., the opaque black matrix, not shown). As shown in FIG. 1C, the vertical stripes M are light beams L after passing through the light blocking layer, and the slant stripes N are formed by the diagonally alternating dark and bright stripes on the light projection face O). The light that comes out of the display panel 11 would reveal interference fringes from optical diffraction. FIG. 1C only shows one such interference fringe in the area A. This is the so-called Moiré phenomenon, adversely affecting the display quality of the display device 1.

To solve this problem, China Patent Publication No. 201210393711.0 teaches a display device 3a shown in FIG. 2. The display device 3a contains a backlight module 2a and a display panel 4. Corresponding to a first sub-pixel R (denoted as Ra) of a first pixel on a first row of the display panel 4, a first light guiding element 211a is configured on a light guide plate 21a. Similarly, corresponding to a third sub-pixel B (denoted as Bb) of a second pixel on a second row of the display panel 4, a second light guiding element 211b is configured on the light guide plate 21a. Corresponding to a first sub-pixel R (denoted as Rc) of a third pixel on a third row of the display panel 4, a third light guiding element 211c is configured on the light guide plate 21a. For brevity the rest of the details is omitted. The geometric centers of the sub-pixels corresponding to the light guiding elements 211 are connected into a line L2 with a number of end-to-end connected segments. The distance between each pair of neighboring L2's is identical. Of course, the distances between different pairs of L2's can also be different.

In other words, each light guiding element 211 with its reflective material 24 configured on a bottom side S1 of the light guide plate 21a is aligned against a sub-pixel on the display panel 4. When light beams L are projected towards the display panel 4 through a top side S2 of the light guide plate 21a and as the light beams L pass through the display panel 4, the light beams L do not interfere with the light blocking layer (i.e., the black matrix) of the display panel 4 and therefore no interference fringe is produced. The display device 3a's display quality is not compromised. However, the light guiding elements 211 have to be accurately aligned with the sub-pixels, thereby increasing the complexity of manufacture and the difficulty of industrializing the display device.

### SUMMARY OF THE INVENTION

To obviate the shortcomings of the prior art, the present invention provides a display panel containing a substrate; multiple pixels; and a black matrix. The pixels are arranged in an array on the substrate. Each pixel contains a number of sub-pixels. The black matrix is a grid on the substrate among the sub-pixels with perpendicular row and column strips. Each column strip between two neighboring columns of pixels is of a same width, and the column strips within a column of pixels between neighboring columns of sub-pixels are of different widths.

More specifically, each pixel contains a first sub-pixel, a second sub-pixel, and a third sub-pixel. Each column strip between a column of first sub-pixels and a neighboring column of second sub-pixels has a smaller width than that of each column strip between a column of second sub-pixels and a neighboring column of third sub-pixels.

More specifically, each column strip between a column of first sub-pixels and a neighboring column of second sub-pixels has a smaller width than that of each column strip between two neighboring columns of pixels. Each column strip between a column of second sub-pixels and a neighboring column of third sub-pixels has a greater width than that of each column strip between two neighboring columns of pixels.

The present invention also provides a display device including the above display panel and a backlight module opposing and illuminating the display panel.

More specifically, the backlight module contains a light guide plate, a number of light guiding elements, and at least a lighting element. The light guide plate has at least a light incident face and two opposing sides. The light guiding elements are arranged along one of the sides, and the lighting element is positioned oppositely along the light incident face.

More specifically, each light guiding element is one of an indented microstructure and a bulging microstructure.

More specifically, the light guiding elements are aligned or not aligned against the sub-pixels.

The advantages of the present invention are as follows. Light beams projected from the light guide plate of the backlight module onto the display panel are diagonally aligned as the light guiding elements are diagonally arranged on the light guide plate. The light beams, when they pass through the display panel, are not diffracted by the black matrix due to the black matrix's column strips between sub-pixels are of different widths, and therefore no interference fringe is produced. The display quality of the display device is not compromised. In addition, the light guiding elements are not required to be aligned against the sub-pixels, achieving significantly reduced manufacture complexity and enhanced industrialization.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIGS. 1A and 1B are perspective and side-view diagrams of an existing display device;

FIG. 1C is a schematic diagram showing interference fringes produced by the existing display device of FIGS. 1A and 1B;

FIG. 2 is a perspective diagram showing an existing display device capable of avoiding interference fringes;

FIG. 3 is a perspective diagram showing a display device according to an embodiment of the present invention;

FIG. 4 is a side-view diagram showing a display panel according to an embodiment of the present invention; and

FIG. 5 is a top-view diagram showing the display panel of FIG. 4.

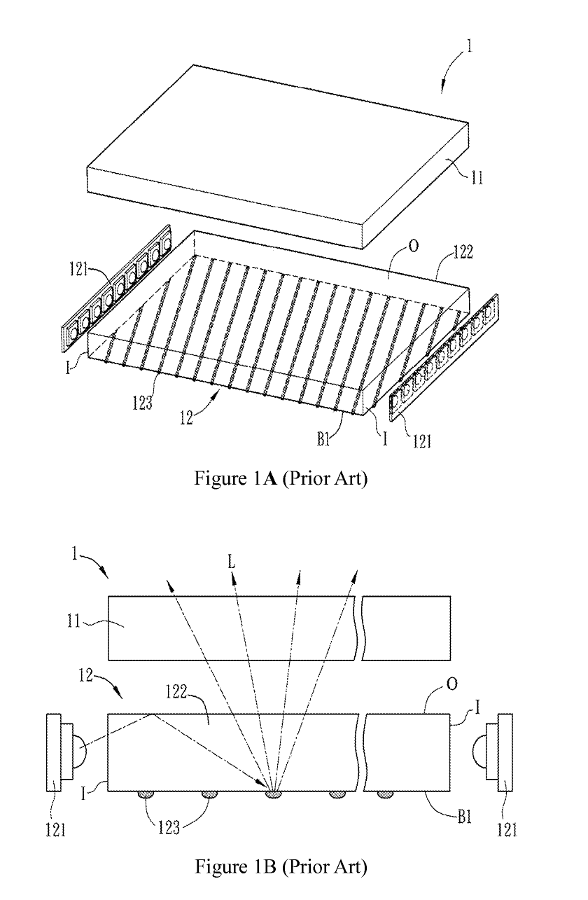

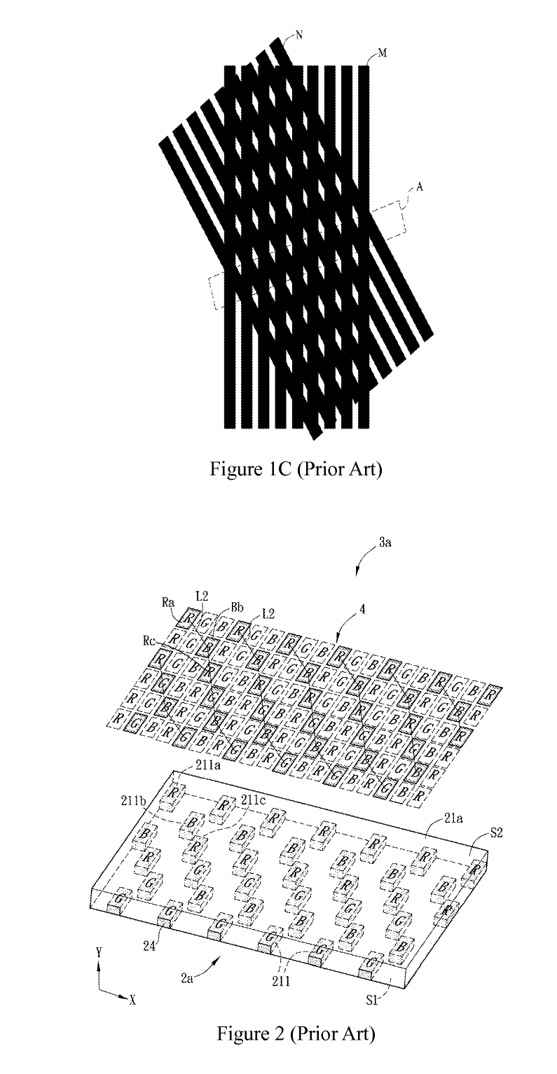

### DETAILED DESCRIPTION OF THE PREFERRED EMBODIMENTS

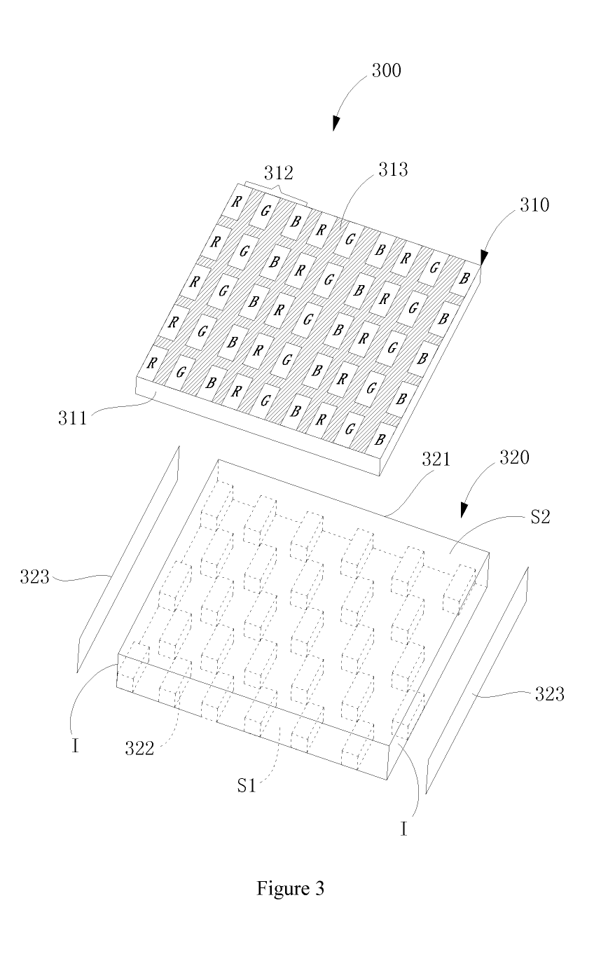

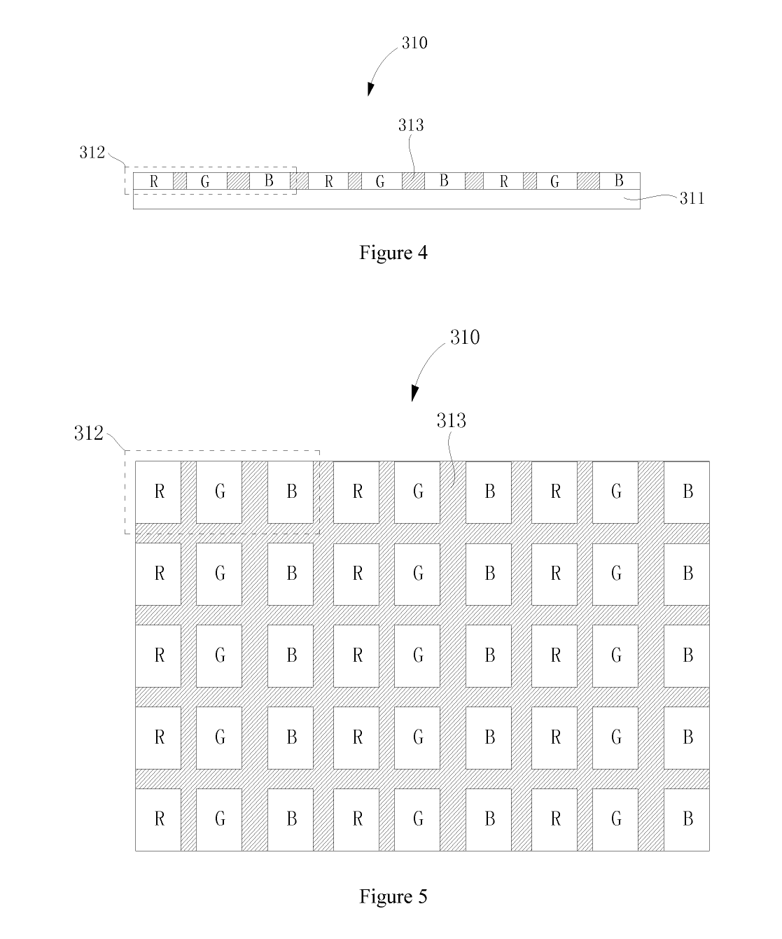

FIG. 3 is a perspective diagram showing a display device 300 according to an embodiment of the present invention. FIG. 4 is a side-view diagram showing a display panel 310 according to an embodiment of the present invention. FIG. 5 is a top-view diagram showing the display panel 310.

As shown in FIGS. 3 to 5, the display device 300 contains the display panel 310 and a backlight module 320.

The display panel 310 contains a substrate 311, a number of pixels 312, and a black matrix 313. The substrate 311 can be a transparent glass substrate or a transparent resin substrate.

The pixels 312 are arranged in an array on the substrate 311 and each pixel 312 contains three sub-pixels (i.e., a first sub-pixel R, a second sub-pixel G, and a third sub-pixel B). In the present embodiment, the sub-pixels R, G, and B are arranged along a row direction of the array. Therefore, each column of the array is of sub-pixels of a same type R, G, or B.

In the present embodiment, the first sub-pixel R is a red sub-pixel, the second sub-pixel G is a green sub-pixel, and the third sub-pixel B is a blue sub-pixel.

The black matrix 313 is formed on the substrate 311 among the sub-pixels R, G, and B, and as such the black matrix 313 is a grid with a number of perpendicular row and column strips. In the present embodiment, each column strip of the black matrix 313 between two neighboring columns of pixels 312 of a same width, whereas the column strips within a column of pixels 312 between neighboring columns of sub-pixels are of different widths.

More specifically, each column strip between a column of first sub-pixels R and a neighboring column of second sub-pixels G has a smaller width than that of each column strip between two neighboring columns of pixels 312. Each column strip between a column of second sub-pixels G and a neighboring column of third sub-pixels B has a greater width than that of each column strip between two neighboring columns of pixels 312. However, the present invention is not limited to this arrangement. In an alternative embodiment, each column strip between a column of first sub-pixels R and a neighboring column of second sub-pixels G has a greater width, and each column strip between a column of second sub-pixels G and a neighboring column of third sub-pixels B has a smaller width than that of each column strip between two neighboring columns of pixels 312.

In the present embodiment, each column strip between two neighboring columns of pixels 312 has a width 4 μm, each column strip between a column of first sub-pixels R and a neighboring column of second sub-pixels G has a width 3 μm, and Each column strip between a column of second sub-pixels G and a neighboring column of third sub-pixels B has a width 5 μm.

The backlight module 320 is oppositely positioned relative to the display panel 310. The backlight module 320 contains a light guide plate 321, a number of light guiding elements 322, and at least a lighting element 323.

The light guide plate 321 controls the direction of light, and has at least a light incident face I and two opposing sides S1 and S2. The major face S1 is on a bottom side, and the major face S2 is on a top side of the light guide plate 321. In the present embodiment, the major face S2 is a light projection face, but the present invention is not limited to this arrangement. In an alternative embodiment, the major face S1 is the light projection face. The light guide plate 321 is made of a transparent material such as acrylic resin, polycarbonate, polyvinyl resin, glass, etc. In addition, the light guide plate 321 can have a rectangular or wedge-shaped cross-section. In the present embodiment, the light guide plate 321 has a rectangular cross-section.

The light guiding elements 322 are arranged along one of the sides S1 and S2. In the present embodiment, the light guiding elements 322 are on the major face S1. In an alternative embodiment, the light guiding elements 322 are on the other major face S2. The present invention does not limit the number of light guiding elements 322. Any two light guiding elements 322 do not cross, overlap, and connect with each other.

In the present embodiment, the light guiding elements 322 are microstructures (such as indentations) indented toward the major face S2. The light guiding elements 322 can be formed using etching, optical, or mechanical means. Alternatively, the light guiding elements 322 can also be bulging microstructures, achieving an identical effect. In addition, the light guiding elements 322 are arranged diagonally on the major face S1, and the distance between each pair of neighboring diagonal lines of light guiding elements 322 is identical. Of course, in an alternative embodiment, the distance can also be different.

In addition, in the present embodiment, the light guiding elements 322 are not aligned against the sub-pixels. However, in an alternative embodiment, each light guiding element 322 can be aligned right against a sub-pixel.

The lighting element 323 is positioned oppositely along the light incident face I of the light guide plate 321. In the present embodiment, there are two lighting elements 323 positioned oppositely along two opposing light incident faces I of the light guide plate 321. The light emitted from the lighting elements 323 enters the light guide plate 321 through the light incident faces I, and then projects out of the light guide plate 321 through the major face S2 (i.e., the light projection face). Each lighting element 323 may contains at least a light emitting diode (LED), at least an organic LED (OLED), at least a cold cathode fluorescent lamp (CCFL), or at least a hot cathode fluorescent lamp (HCFL) as light sourced. In the present embodiment, each lighting element 323 is a LED light bar containing a number of LEDs on a circuit board.

Through experimenting the display device 300 of the present embodiment, light beams are projected towards the display panel 310 through the light guide plate 321's major face S2 of the backlight module 320. As light travels within the light guide plate 321, due to the diagonally arranged light guiding elements 322 on the major face S1, light beams projected out of the light guide plate 321 by the light guiding elements 322 are also diagonally aligned. These diagonally aligned light beams are not diffracted by the black matrix 313 on the display panel 310 due to the black matrix 313's column strips between sub-pixels are of different widths, and therefore no interference fringe is produced. The display quality of the display device 300 is not compromised. In addition, the light guiding elements 322 are not required to be aligned against the sub-pixels, achieving significantly reduced manufacture complexity and enhanced industrialization.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A display panel, comprising:
a substrate;
a plurality of pixels; and
a black matrix;
wherein the pixels are arranged in an array on the substrate; each pixel comprises a plurality of sub-pixels; the black matrix is a grid on the substrate among the sub-pixels; the black matrix between two neighboring pixels is of a same width; and the black matrix between two neighboring sub-pixels of each pixel are of different widths.

2. The display panel as claimed in claim 1, wherein each pixel comprises a first sub-pixel, a second sub-pixel, and a third sub-pixel; and a width of the black matrix between the first sub-pixels and the second sub-pixels is smaller than a width of the black matrix between the second sub-pixels and the third sub-pixels.

3. The display panel as claimed in claim 2, wherein the black matrix between the first sub-pixels and the second sub-pixels has a smaller width than the black matrix between two neighboring pixels; and the black matrix between the second sub-pixels and the third sub-pixels has a greater width than the black matrix between two neighboring pixels.

4. A display device, comprising:
a display panel; and
a backlight module opposing and illuminating the display panel;
wherein the display panel comprises a substrate; a plurality of pixels; and a black matrix; the pixels are arranged in an array on the substrate; each pixel comprises a plurality of sub-pixels; the black matrix is a grid on the substrate among the sub-pixels; the black matrix between two neighboring pixels is of a same width; and the black matrix between two neighboring sub-pixels of each pixel are of different widths.

5. The display device as claimed in claim 4, wherein each pixel comprises a first sub-pixel, a second sub-pixel, and a third sub-pixel; and a width of the black matrix between the first sub-pixels and the second sub-pixels is smaller than a width of the black matrix between the second sub-pixels and the third sub-pixels.

6. The display device as claimed in claim 5, wherein the black matrix between the first sub-pixels and the second sub-pixels has a smaller width than the black matrix between two neighboring pixels; and the black matrix between the second sub-pixels and the third sub-pixels has a greater width than the black matrix between two neighboring pixels.

7. The display device as claimed in claim 4, wherein the backlight module comprises a light guide plate, a plurality of light guiding elements, and at least a lighting element; the light guide plate has at least a light incident face and two opposing sides; the light guiding elements are arranged along one of the sides; and the lighting element is positioned oppositely along the light incident face.

8. The display device as claimed in claim 7, wherein each light guiding element is one of an indented microstructure and a bulging microstructure.

9. The display device as claimed in claim 7, wherein the light guiding elements are aligned or not aligned against the sub-pixels.

10. The display device as claimed in claim 8, wherein the light guiding elements are aligned or not aligned against the sub-pixels.
